(19) United States
(12) Patent Application Publication
(10) Pub. No.: US 2020/0324445 A1
(43) Pub. Date: Oct. 15, 2020

(54) METHOD OF MAKING A CONSTRUCTION PANEL

(71) Applicant: Maximilian PRINZ, Passau (DE)

(72) Inventor: Maximilian PRINZ, Passau (DE)

(21) Appl. No.: 16/843,956

(22) Filed: Apr. 9, 2020

(30) Foreign Application Priority Data
Apr. 12, 2019 (DE) 102019109820.3

(51) Int. Cl. B29C 44/44; B29C 44/12; B29C 44/56

(52) U.S. Cl. CPC B29C 44/445; B29K 2105/048; B29C 44/5681; B29C 44/1285

(57) ABSTRACT

The invention relates, inter alia, to a method of making a thin component (10) in a lightweight sandwich construction having a high-quality surface (26).

The invention relates to a method of making a thin component in a lightweight sandwich construction having a high-quality surface.

Methods of this kind have been developed and implemented on a large scale by applicant for decades.

Solely by way of example, reference is made to the following German patent applications by applicant:

DE 10 2018 117 337, DE 10 2017 109 953, DE 10 2016 112 290 A1, DE 10 2013 018 694 A1, DE 10 2013 008 592 A1, DE 10 2013 005 523 A1, DE 10 2013 008 364 A1, DE 10 2015 111 052 A1 and DE 10 2012 017 698 A1,

whose content is hereby incorporated in the content of the present patent application in order to avoid repetition.

For the sake of completeness, reference is made to the subsequently published German patent application DE 10 2018 123 703 A1 [US 2020/0094449] by applicant.

The methods predominantly used by applicant until now of making such a thin component in particular include connecting thermoplastic deep-drawn films to polyurethane foam masses.

Proceeding therefrom, the problem addressed by the invention is to provide a method that can make a thin component that meets the requirements of low weight and high rigidity, that can have a high-quality surface, and that can be cost-effectively manufactured.

The invention solves this problem by the features of claim 1.

The principle of the invention first consists in an expandable particle foam being used instead of the polyurethane two-component foams that have previously been used.

Particle foams made of EPS, EPE and EPP, for example, are possible as suitable expandable particle foams. In this case, these are particle foams that can have densities that are typically in the range of from 15 kg/m³ to 80 kg/m³ once fully or completely expanded and foamed.

According to the invention, the starting material is provided in the form of loose particles of an expandable particle foam, the particle foam, when expanded, having a softening temperature, in particular a VICAT softening temperature, of greater than 160° C. Advantageously, materials are selected of which the softening temperature when expanded is above 180° C., in particular advantageously of greater than 200° C., more advantageously of greater than 220° C., more advantageously of greater than 235° C.

The VICAT softening temperature is a physical variable for quantitatively characterizing the dimensional stability of a plastics material. This information is used to determine the heat deflection temperature. For this purpose, reference is made in particular to the DIN EN ISO 306(2) standard.

According to the invention, materials can for example be used that are available under the trade name Ultrason by BASF SE with the names PSU, PESU or PPSU. According to some data sheets (as can be viewed at www.Kern.de for polyphenylsulfone (PPSU)), VICAT softening temperatures are not explicitly stated. However, these data sheets provide information regarding the heat deflection temperatures at 207° C. and 214° C. as well as a melting point according to ISO 11357 of 215° C. Other data sheets (such as from ALBIS for PESU-GF20) state a VICAT softening temperature of 217° C.

Depending on the material, determining the VICAT softening temperature is associated with difficulties. In these cases, as an alternative to determining the softening temperature, recourse can be made to determining the glass transition temperature or determining the heat deflection temperature or determining the melting point of the expanded granulate particles. These above-mentioned temperatures generally deviate from the VICAT softening temperature by just a few percentage points.

If the VICAT softening temperature can be determined for a substance in accordance with the above-mentioned standard, the determination of the VICAT softening temperature should take precedence, however.

According to a variant of the invention, a film-like substrate is first provided. This may for example be a film that can be deep-drawn, e.g. made of ABS or PMMA. This may have a wall thickness of between 0.2 mm and 13 mm. The film may for example be deep-drawn in a first mold. The substrate used may, however, be provided by a thin skin, a thin film, or another thin material. The substrate does not have to be deep-drawn.

According to this variant of the invention, the substrate is arranged in a lower mold part. The lower mold part provides a receiving space.

It should be noted at this point that, according to a variant of the invention, the provision of such a film-like substrate can also be omitted. In this variant of the invention, the component to be manufactured can be manufactured without such a film or substrate.

The method according to the invention provides that granular starting material in the form of loose particles of an expandable particle foam is provided. Those materials that are known as expandable particle foams are possible. In particular, these are understood to be particle foams made of EPS, EPE or EPP, or also expandable PEEK. There is another definition further on.

The granular starting material may be provided in the used form of small spheres or beads, or in the form of granular particles having different regular or irregular shapes and geometries. The starting material is in particular pourable.

The particles are provided so as to be loose in the granular starting material, i.e. are in particular not joined together.

According to a variant of the invention, the step of partial expanding of the particles is carried out first. Partial expanding means that the particles are not yet completely expanded. For example, it may be provided according to the invention that, based on an expanding or expansion process from 0% to 100%, proceeding from the volume of the particles of the starting material up to the volume of the particle when completely expanded, partial expanding of between 30% and 95% takes place. The term “partial expanding” in particular includes embodiments of the invention in which at least the step of additionally expanding the particles can still be carried out, through to a completely expanded state of the particles.

The step of partial expanding takes place in particular, but not necessarily, in a position that is remote from the lower mold part in which the substrate is arranged. More advantageously, the partial expanding of the particles can be carried out in an oven, in particular in an infrared oven.

According to another step of the variant of the method according to the invention, it may be provided that the partially expanded particles are placed into the lower mold part. The partially expanded particles may, for example, be immediately transported after the step of partially expanding the particles has been carried out. However, said partially expanded particles may also be transported at a considerably later point in time after the step of partially expanding the particles has been carried out. The partially expanded particles can be placed and/or arranged or positioned in the lower mold part by a machine, in an automated manner, or manually.

According to the invention, the mold is then closed. To do this, an upper mold part can be moved towards the lower mold part and a receiving space or cavity for the partially expanded particles, as well as for the substrate positioned in the lower mold part.

According to the invention, the mold is then heated. The invention also covers the case in which the mold is consistently kept at a constant temperature or at a temperature within a predetermined temperature range.

According to the invention, the previously already partially expanded particles are then fully expanded to form a completely expanded particle foam. The particles then expand to their maximum extent or to their maximum volume, and bake or sinter to one another, as it were. In the process, the particle-foam mass simultaneously binds to the substrate. The remaining expanding process is activated by the mold temperature. The invention also covers the case in which, additionally or alternatively, other activation agents are used to activate and carry out the remaining expanding process of the particles, i.e. for the expanding process of the already partially expanded particles through to a fully expanded state of the particles.

According to the invention, the particle-foam mass is allowed to cure. Owing to this curing process, the particle-foam mass forms a permanent, firm bond with the substrate.

The invention also covers the case in which the substrate is provided with a corresponding chemical, e.g. in the manner of an adhesive primer, on its inner face facing the particle-foam mass before the partially expanded particles are placed into the lower mold part, in order to optimize the bond between the substrate and the particle-foam mass or the formation of the bond between the substrate and the particle-foam mass.

After allowing the particle-foam mass to cure, the mold can be opened, and the molded body thus formed can be removed. The molded body thus formed constitutes the component to be manufactured according to the invention, or can be developed into such a component by subsequent processing steps.

### Definition of Expandable Particle Foam

The following materials are considered to be expandable particle foams within the meaning of the present patent application, for example:

The abbreviation EPS means expandable polystyrene. This is, for example, known by the brand name Styropor, and can e.g. be sourced from Metz EPS-Hartschaumzuschnitte in 74376 Gemmrigheim.

Expandable polyethylenes (EPE) are also considered to be a particle foam within the meaning of the present patent application. Lastly, expandable polypropylenes (EPP) are also considered to be well suited to the purposes according to the invention.

In particular, thermoplastic particle foams are in particular covered by the term particle foam within the meaning of the present patent application. These may comprise, as a starting material, a granulate, in particular also a microgranulate, for example having diameters of the particles in the order of magnitude of between 0.1 mm and 5 mm, more preferably particles having a diameter of approx. 1 mm.

Blowing agents are preferably arranged in the granular starting-material particles of the particle foam. Said blowing agents may be activated thermally and/or by chemicals, for example also by the action of water vapor, in order to initiate the pre-expanding process.

The process of the remaining expanding, i.e. completely expanding pre-expanded particles to form completely expanded particles, is also referred to as sintering within the meaning of the present patent application.

Pentane, which is polymerized into the granular particles, is taken into consideration for polystyrene particle-foam particles, for example. Once the particles are exposed to temperatures of above 100° C., the blowing agent can evaporate and, in the process, inflates the thermoplastic base material to form polystyrene foam particles.

The second expanding step can be carried out in the lower mold part according to the invention, with the mold temperature being selected such that the blowing agent can completely evaporate, and the particles can completely foam.

Lastly, the variant of the invention has been described according to which granular starting material in the form of loose particles is first pre-expanded, and these pre-expanded particles, which are still in the form of granular particles, are placed into the lower mold part and baked therein. However, according to a variant, the invention equally includes a method and a component made according to this method, in which the granular starting material in the form of loose particles is completely expanded, and is then placed into the mold while still being in an aggregate state in the form of a loose granulate. In this last-described variant, no further increase in volume takes place while the expanded particles are baked in the mold.

Lastly, for the sake of completeness, it is noted that the invention also includes methods in which the mold can also be overloaded, for example, or in which a reduction in the volume of the expanded particles inserted into the mold takes place in another way over the course of the baking process.

It is also noted that, while baking the expanded particles, the mold is at a temperature that is above the VICAT softening temperature.

Furthermore, it is additionally noted at this point that, in the preceding passages, a variant of the invention has been described in which, before introducing the expanded particles into the mold, a film or substrate is arranged in the lower mold part and the step of baking the expanded particles to this substrate is carried out.

However, the invention also includes a variant in which the expanded particles are placed directly into the mold and are baked therein without a film or substrate having been inserted into the mold in advance.

In addition to EPS (extruded polystyrene), XPS is also taken into consideration for the invention.

For example, Schaumaplast GmbH & Co. KG in 68799 Reilingen comes into consideration as a reference source for expandable polypropylene EPP or XPS.

Particle foams for use with the invention can also be provided by expandable copolymers. Materials of this kind can be sourced under the trade name Grupor from the plastics manufacturing facility Katzbach GmbH & Co. KG in 93413 Cham, for example.

Expandable PEEK (polyether ether ketone) is also taken into consideration as a starting material for the particle foam that can be used in the context of the invention. This can be sourced under the trade names Gatone or Victrex, for example.

According to the invention, while the expanded particles are being baked to form a homogenous curable particle foam, the mold is heated to a temperature above the VICAT softening temperature of the particle foam such that the particles can bake to one another. The mold is then cooled to a temperature below the VICAT softening temperature such that the particle foam cures. After curing the foam, the molded body can be removed from the mold.

According to the invention, in another step a coating layer is applied to the surface of the molded body. In this case, a coating layer, or a plurality of coating layers in succession, can be applied to the entire surface of the molded body or to a portion of the molded body or to a plurality of portions of the molded body.

In a variant of the invention, the coating layer can be applied as part of a cathodic dip coating process. Here, the molded body is completely or partially immersed in an immersion bath and a cathodic dip coating method that is known per se is used. In this process, high temperatures can act on the molded body. Advantageously, the step of applying the coating layer takes place at a temperature below the VICAT softening temperature of the cured particle-foam mass.

In a variant of the invention, the coating layer is applied as part of a powder coating method. Here too, it is provided according to the invention that the step of applying the coating layer takes place at a temperature below the VICAT softening temperature.

According to the invention, it is further provided that a step of drying the coating layer takes place, in particular at a high temperature that is selected such that it is below the VICAT softening temperature of the particle foam.

According to the invention, lightweight components can be manufactured and coated, and conventional coating methods can be used that, until now, have only been used for coating metal components, for example. The components made using the method according to the invention can therefore be coated on existing coating lines of the coating apparatuses or devices using conventional coating methods.

The method according to the invention serves to produce a component having a high-quality surface. A high-quality surface may for example be particularly resilient, e.g. may be designed to be particularly impact-resistant, and furthermore may be particularly suitable for outdoor applications. In particular, a high-quality surface may have properties as required by so-called class A surfaces.

By applying a coating layer in a conventional high-quality coating process, a high-quality surface of this kind can be provided on the component.

If the component comprises a film or another suitable substrate, e.g. a thin metal film, which has been placed into the lower mold part before the expanded particles are inserted, the film or substrate can also be covered by the coating layer.

The invention relates to a method of making a thin component. The term “thin” means that the component has a considerably longer extension along a surface in the x and y directions than in a z direction perpendicular thereto. The surface may be flat or curved in space, or even curved multiple times, and may take any spatial form.

According to an advantageous embodiment of the invention, step ix) of applying a coating layer to a surface of the molded body and/or step x) of drying the coating layer are carried out at a high temperature, in particular a temperature above 150° C. The provides the option of utilizing known methods for applying a coating layer that, until now, have only been used for metal components or components manufactured from plastics injection-molded parts.

In another advantageous embodiment of the invention, the coating layer has a thickness of between 0.01 mm and 2 mm when cured.

According to an advantageous embodiment of the invention, the component comprises a substrate that is provided by a deep-drawn film. This makes it possible to utilize conventional constituents of a component that have already been comprehensively tested and that particularly make it possible to provide a high-quality surface for the component.

According to another advantageous embodiment of the invention, in addition, step xi) is carried out as follows: applying a cover layer to the face of the particle-foam mass directed away from the substrate.

Such a cover layer may for example be an interior decorative layer, for example wall paneling, in particular a plastics layer. If the manufactured component forms a wall or a wall portion of a caravan or a caravan trailer, for example, the decorative layer may e.g. be a typical interior fitting surface of such a caravan in a conventional manner.

According to another advantageous embodiment of the invention, the method according to the invention comprises the following step:

xii) processing the molded body to form a component.

Various processing methods come into consideration as processing steps. These include, for example, separating or cutting off parts or regions of the molded body, optionally also separating or cutting off portions of the substrate. These include, for example, a cleaning step and/or a surface-processing step, in particular on the outer face of the substrate, for example roughening or polishing or smoothing the substrate, optionally also applying an additional layer or film, for example an additional functional layer.

The invention also covers the case in which the face of the cured particle-foam mass directed away from the substrate is processed, for example is connected to an additional skin or an additional material or a film or has an additional skin or an additional material or a film applied thereto, e.g. sprayed thereon, bonded thereto, coated thereon, riveted thereto, screwed thereto, or bonded to another element.

According to another advantageous embodiment of the invention, the film has a wall thickness of between 0.2 mm and 13 mm. This embodiment of the invention likewise makes it possible to utilize conventional films that have been able to be tested with many composite materials and of which the deep-drawing properties and surface properties are sufficiently well known and have been adequately researched.

According to another advantageous embodiment of the invention, the cured particle-foam mass has a wall thickness of between 1 cm and 30 cm. Depending on the required strengths of the manufactured component, the wall thickness of the cured particle-foam mass is calculated and configured. Despite the comparatively large wall thicknesses, the final manufactured component can have only a very low weight.

According to another advantageous embodiment of the invention, the component is a vehicle part for a truck, or for a commercial vehicle, or for a trailer, and is, for example, an interior fitting, or a cargo-space cover, or a trim part, or a hood, or a roof element, or a roof segment, or a vehicle wall, or a vehicle wall element.

According to another advantageous embodiment of the invention, the granular starting material comprises expandable EPS, expandable EPP or expandable PEEK. These are all materials that can be expanded, i.e. are expandable, and that, according to the invention, are suitable for first being only partially expanded or expanded in order to subsequently undergo a step of final expanding or final expansion in a mold.

According to another advantageous embodiment of the invention, the method comprises step xiii) that is carried out before step vi):

xiii) positioning reinforcing elements, in particular in the manner of tie rods, for example in the manner of tapes, in the lower mold part, the partially expanded particles enveloping the reinforcing elements after the particles have been placed into the lower mold part.

According to this advantageous embodiment of the invention, the completely expanded, expanded particle-foam mass is reinforced or rigidified by reinforcing elements. These elements are in particular designed such that they can transmit or absorb tensile forces in a direction transverse to the thin extension of the component. This means that the rigidity of the component can be increased. The invention also covers the case in which the reinforcing elements extend in the extension direction of the thin component. In this case, thin fabrics such as mats, laid webs, knitted fabrics, etc. made of reinforcement fibers, for example of glass fibers, carbon fibers, aramid fibers, basalt fibers or other suitable reinforcement fibers can also be laid into the lower mold part before the cavity is filled with partially expanded particles.

According to another aspect, the invention relates to a thin component according to claim 17.

The problem addressed by the invention is to provide a component that has high strength and a high load-bearing capacity while only having a low weight and that can be manufactured cost-effectively.

The invention solves this problem by means of the features of claim 17.

In order to avoid repetition with regard to the explanation of the features of claim 17 and in order to explain the invention according to claim 11, reference is made to the preceding comments on claims 1 to 16 in an analogous manner.

Other advantages of the invention become apparent from the dependent claims that have not been cited, as well as with reference to the following description of the embodiments shown in the drawings, in which:

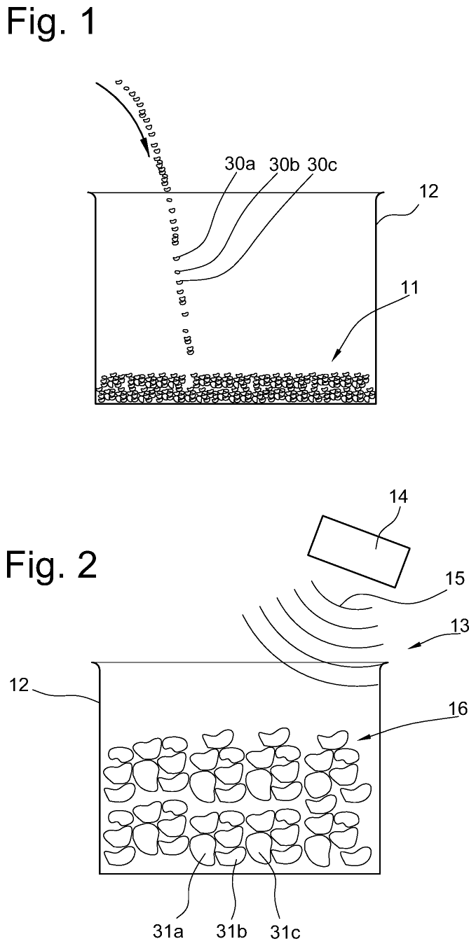

FIG. 1 is a partially sectional schematic view of an embodiment of an oven, into which granular starting material in the form of particles of a particle foam is being poured, the granular starting material being unexpanded,

FIG. 2 shows the oven from FIG. 1, with an infrared radiant heater additionally being shown, the particles that were previously poured in having been brought into a partially expanded state,

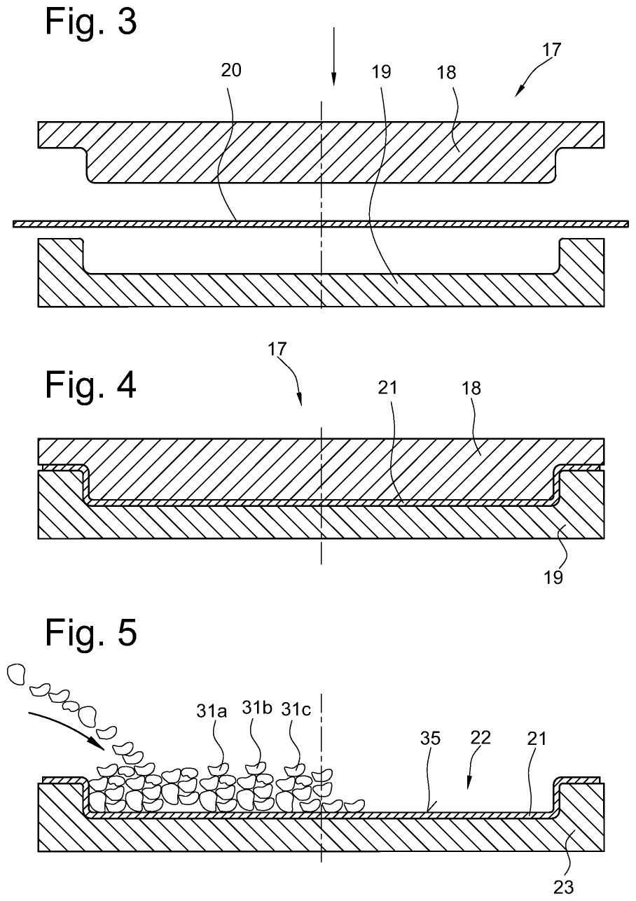

FIG. 3 shows a first mold comprising a lower mold part and an upper mold part and a film that is a web-shaped, flat state in the form of a substrate,

FIG. 4 shows the closed mold from FIG. 3 with the deep-drawn film,

FIG. 5 shows another mold, in which the deep-drawn film from FIG. 4 is positioned, the partially expanded particles of the particle foam according to FIG. 2 being poured into the lower mold part,

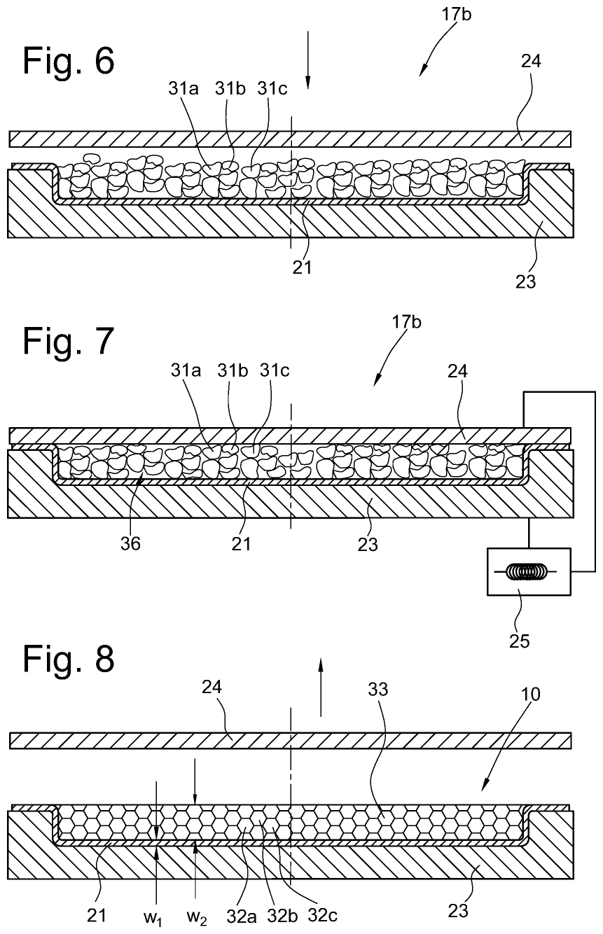

FIG. 6 shows the mold from FIG. 5 with the additionally shown upper mold part just before the mold is completely closed,

FIG. 7 shows the tool from FIG. 6 in a completely closed state, with a heating device for the mold additionally being shown,

FIG. 8 shows the tool from FIG. 7 in an open state with the completely expanded, cured particle-foam mass,

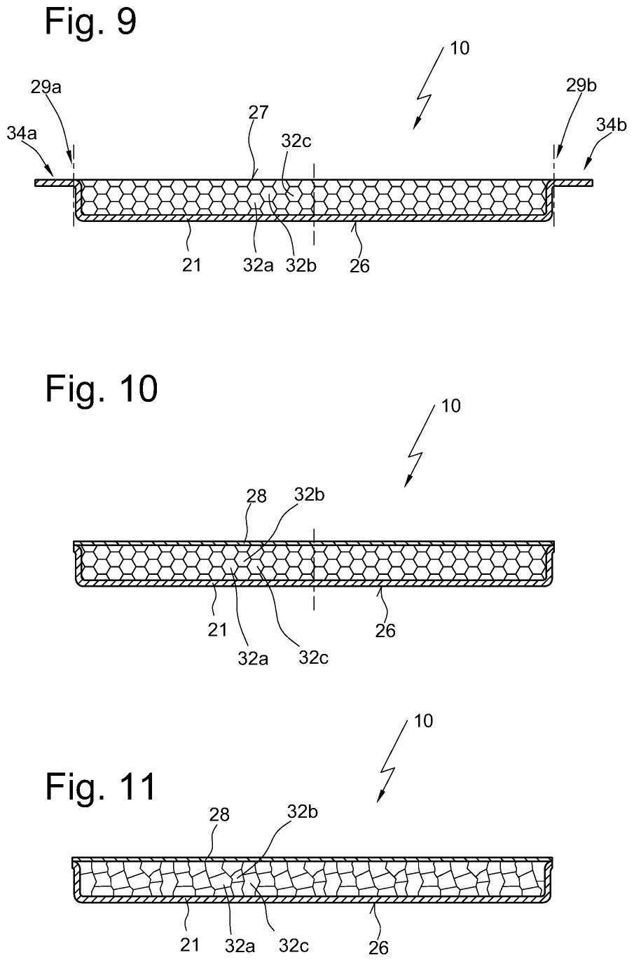

FIG. 9 shows the molded body removed from the mold from FIG. 8 and shows cutting lines along which the excess regions of the substrate are cut off,

FIG. 10 shows another embodiment of a molded body or a component according to the invention formed in a method according to the invention, comprising an additional layer on the face of the cured particle-foam mass directed away from the substrate,

FIG. 11 shows another embodiment of a component according to the invention in a view according to FIG. 10, wherein, solely for the purposes of illustration, the pore structure of the cured particle foam is shown such that it is altered compared with FIG. 10,

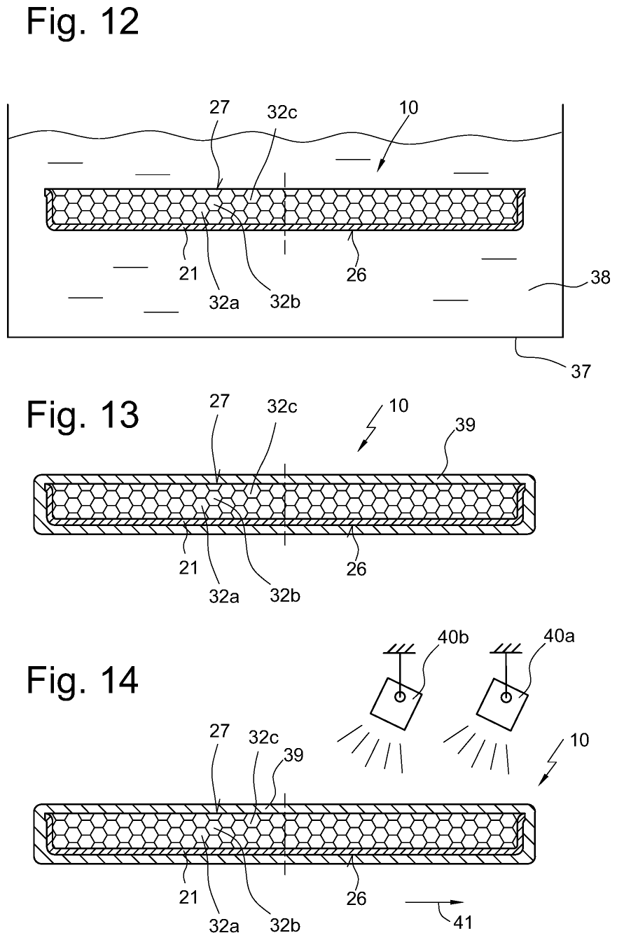

FIG. 12 shows, in order to illustrate a step of applying a coating layer in an embodiment of the method according to the invention, the molded body or the completed component according to FIG. 9, after cutting off the excess regions, so as to be arranged in an immersion bath for carrying out a cathodic dip coating step,

FIG. 13 shows just the component that has been removed from the immersion bath from FIG. 12 and is now provided with a coating layer,

FIG. 14 shows the coated component according to FIG. 13 in a drying apparatus,

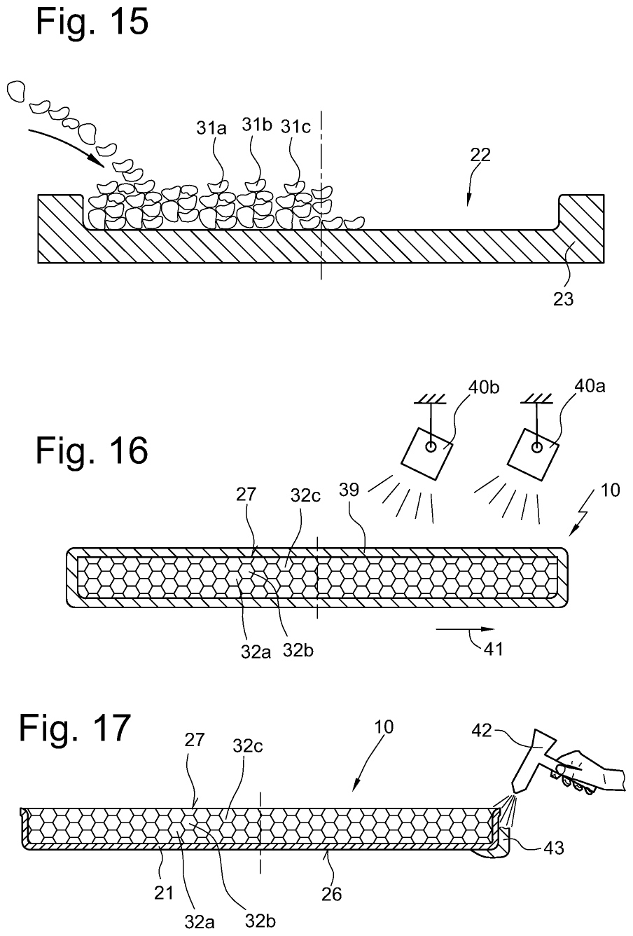

FIG. 15 shows a lower mold part in a view according to FIG. 5, into which expanded particles are introduced, with no substrate being arranged in the lower mold part, by contrast with the embodiment in FIG. 5,

FIG. 16 shows, in a view according to FIG. 14, a step in the process for drying a component that is provided with a coating layer, has been made following a method according to FIG. 15, and comprises a coating layer but not a substrate, and

FIG. 17 shows, in a view according to FIG. 12, the application of a coating layer to a molded body according to FIG. 9 by an application apparatus as part of a powder coating method.

Embodiments of the invention are described by way of example in the following description of the figures, also with reference to the drawings. Here, for the sake of clarity, even if different embodiments are involved, identical or comparable parts or elements have been denoted by identical reference signs, sometimes with the addition of lower case letters.

Features that are only described, set out or disclosed in relation to one embodiment can also be provided in any other embodiment of the invention within the scope of the invention. Even if they are not shown in the drawings, such amended embodiments are covered by the invention.

All the features disclosed are essential to the invention per se. The content of the disclosure of the associated priority documents (copy of the previous application) and the cited documents and the prior art devices described are hereby incorporated into the disclosure of the application in their entirety, also for the purpose of incorporating individual features or a plurality of features of the subjects disclosed therein into one or more claims of the present application. Even if they are not shown in the drawings, such amended embodiments are also covered by the invention.

In the following, proceeding from FIG. 1, the method for manufacturing a component 10 shall be set out:

According to FIG. 1, a container 12 is shown into which a granulate 11 of a particle foam is poured. The individual granulate particles, which are denoted by reference signs 30a, 30b, 30c by way of example, are unexpanded, and constitute the starting material for manufacturing a particle foam. Greater detail will be given in the following regarding the individual materials that can be used in the method according to the invention.

According to FIG. 2, the container 12 is part of an oven 13 in which the granulate particles 30a, 30b, 30c can be partially expanded:

For this purpose, a heater 14, in particular an infrared heater 14, is provided, which introduces a predetermined radiant power into the oven 13 using infrared rays 15 (indicated), in order to reach a certain temperature or a certain temperature range. The granulate particles 30a, 30b, 30c are subjected to the effects of the temperature in the oven 13 for a predetermined time and partially foam. It can be seen that the individual particles 30a, 30b, 30c in FIG. 1 considerably increase in volume and, according to FIG. 2, turn into partially expanded particles 31a, 31b, 31c. It should be noted that the drawings should not be understood as being to scale, but instead that the process of expanding and the increases in volume are only intended to be shown by way of example.

The partially expanded particles 31a, 31b, 31c are still loose, in particular not joined to one another. During the process of partially expanding according to FIG. 2, by additional measures such as shaking the container 12, stirring, using chemicals, or introducing chemicals into the container 12, it can be achieved that the particles 31a, 31b, 31c do not become joined to one another or predominantly do not become joined to one another, but instead can still be transported as a loose, pourable or at least free-flowing mass. According to FIG. 5, this mass is poured into a lower mold part 23 of a mold 17b.

The production of the substrate 21 shall first be explained with reference to FIGS. 3 to 4:

According to FIG. 3, a first mold 17 is provided that comprises an upper mold part 18 and a lower mold part 19. The relevant mold parts can be designed in the manner of a female mold and in the manner of a male mold. FIG. 3 shows a film 20 in a flat, web-shaped state, i.e. an initial state. FIG. 3 shows the mold when open.

Owing to the mold being closed, the film 20 is deep-drawn from the flat state. The deep-drawing process can impart any spatial contour to the film. The deep-drawing process can be assisted by temperature in a conventional manner, and this is not shown in the drawings. For the deep-drawing process, as an alternative to the embossing/molding process used in the mold 17 in FIG. 3, blow-molding methods, or other shaping methods in which the film is heated and brought into its final shape by applying a vacuum are also possible.

After opening the mold 17 from the state in FIG. 4, the deep-drawn film 21 can be removed and transported to another mold. A second mold 17b of this kind is shown in FIGS. 5 to 8.

The invention also covers the case in which the film 21 remains in the lower mold part 19 after the deep-drawing process, and only the upper mold part is changed. In the following, it is assumed that, proceeding from FIG. 5, the deep-drawn film 21 has been placed into another, second lower mold part 23 of another mold 17b.

According to FIG. 5, the pourable or free-flowing mass made of partially expanded particles 31a, 31b, 31c is placed into the lower mold part 23 in a cavity 22 that serves to receive the partially expanded particles 31a, 31b, 31c and faces the rear face 35 of the deep-drawn film 21. The filling of the second lower mold part 23 or the cavity 22 provided therefor can be carried out manually or by a machine or in a machine-assisted manner until a predetermined volume or predetermined mass of partially expanded particles 31a, 31b, 31c is positioned and in particular distributed in the cavity 22.

Here, a delivery or output device (not shown in the drawings) may be provided that evenly distributes the particles along the cavity 22 in the manner of a feed head.

The mold 17b is then closed. For this purpose, an upper mold part 24 is moved into a closed state, starting from a state according to FIG. 6 in which the mold 17b is still partially open. The cavity 22 is then closed on all sides.

FIG. 7 shows a heater 25 that temperature-controls the mold 17b, preferably both the lower mold part 23 and the upper mold part 24. The mold temperature is selected depending on the materials used for the particle foam.

In particular, it is provided that the mold is temperature-controlled to a mold temperature that is above the VICAT softening temperature, in order to make it possible to carry out the baking step. After an intended period of action of the temperature, it is provided that the mold temperature is reduced to a temperature below the VICAT softening temperature in order to initiate the curing process.

Owing to the action of the temperature, the partially expanded particles 31a, 31b, 31c are completely expanded. A honeycomb structure can be seen in FIG. 8, and is merely indicated by way of example. This structure can likewise only be understood to be schematic; in fact, the structure of the completely expanded particle foam is irregular. Another comparable structure is shown in FIG. 11:

Here, instead of the frame structure in FIG. 8, an irregular, polygon-like structure is shown in a schematic sectional view.

FIG. 8 makes it clear that the partially expanded particles 31a, 31b, 31c according to FIG. 7 turn into completely expanded particles 32a, 32b, 32c, with there no longer being any spaces between individual expanded particles 32a, 32b, 32c. However, FIG. 7 still shows such spaces, denoted by reference sign 36 by way of example.

It should be noted that the expression “completely expanded particles 32a, 32b, 32c” is misleading:

In fact, the large number of completely expanded particles 32a, 32b, 32c overall forms a completely expanded particle-foam mass 33 or a completely expanded particle foam. According to FIG. 8, this can also cure within a short time, such that, as shown by FIG. 8, the mold can be opened and the upper mold part 24 can be raised from the lower mold part 23. The molded body 10 thus formed can then be removed from the mold.

Owing to the process of complete expanding, with the mold closed, the particle foam becomes permanently and firmly joined to the inner face 35 of the deep-drawn film 21. As a result, a light, rigid and load-bearing composite component that can nevertheless be made cost-effectively is provided.

According to FIG. 9, if required, excess regions 34a, 34b of the film 21 can be cut off along the cutting lines 29a, 29b.

The embodiment in FIG. 10 shows the rear face 27 of the component 10 that can be provided with an additional layer 28, e.g. made of plastics material.

The invention also covers components in which, instead of a deep-drawn film 21 made of ABS or PMMA, a thin film made of polyethylene or polypropylene, or in particular also so-called slush skins, is used as the substrate 21, while ensuring that the deep-drawn film has a VICAT softening temperature in any case or, for a metal film, a melting point that is higher than the temperature applied in the step of applying the coating layer or the step of drying the coating layer that are to be carried out according to the invention.

FIG. 8 indicates, by way of example, the wall thicknesses W1 of the deep-drawn film 21 or of the substrate and W2, namely the wall thickness of the cured particle-foam mass 33. The wall thickness W1 may be between 0.2 mm and 13 mm, and the wall thickness W2 may be between 1 cm and 30 cm.

The invention also in particular covers components that are designed as caravan wall elements. For example, wall portions of a caravan trailer or a caravan, or complete wall elements of a caravan, can be used in vehicle construction, with the use of the method according to the invention.

The invention also covers further embodiments that provide that reinforcing elements are deposited in the cavity 22 before the cavity 22 is filled with partially expanded particles 31a, 31b, 31c.

The reinforcing elements (not shown in the drawings) may e.g. comprise reinforcing fibers. Owing to the cavity 22 being filled with partially expanded particles 31a, 31b, 31c, the particles are evenly distributed and envelop the reinforcing elements on multiple sides, preferably on all sides. The completed component 10 comprises a cured particle-foam mass that securely surrounds the reinforcing elements.

By positioning the reinforcing elements, tensile forces in particular can thus be transmitted or absorbed.

After cutting off the excess regions 34a, 34b or, in alternative variants of the invention, also before cutting off the excess regions 34a, 34b, the component 10 in FIG. 9 is subjected to a step of applying a coating layer 39. For this purpose, two different ways of applying a coating layer shall be explained according to FIGS. 12 and 17:

According to FIG. 12, after being made and removed from the mold, the component 10 in FIG. 9 is arranged in an immersion bath 37, in which a liquid, which is known as the immersion coating 38, is arranged. FIG. 12 shows the component 10 in the completely immersed state. The invention also covers variants in which only a portion of the component 10 that bears the surface to be coated is immersed.

According to FIG. 12, a step of cathodic dip coating takes place. In order to avoid repetition, the physical, chemical, and electrochemical aspects of this method that are known per se will not be discussed. In this case, known devices and methods can be used.

It should be noted that, when introducing the component 10, the immersion coating can have a high temperature of between 150° C. and 220° C., for example. Owing to the fact that, according to the invention, a starting material of an expandable particle foam has been selected that has a VICAT softening temperature of greater than 160° C., and that advantageously has an even higher VICAT softening temperature, this step of immersion coating can be carried out in the first place for the purpose of applying a coating layer 39.

FIG. 13 shows the component 10 after it has been removed from the immersion bath 37, and to which a coating layer 39 is then adhered.

In order to dry the coating layer 39, the component 10 is then transported to a drying device 40. Said device may comprise one or more drying units 40a, 40b that ensure that a high temperature is applied to the component 10. The following applies here: the higher the temperature, the shorter the required dwell time of the component in the drying device 40 and the shorter the drying time.

It should be noted that, according to the invention, the component having the applied coating layer is exposed to a temperature that is in particular higher than 150° C. for the purpose of drying the coating layer. It is also noted that, according to a variant of the invention, the component 10 is exposed to a temperature that is below the VICAT softening temperature of the particle foam for the purpose of drying the coating layer 39.

The arrow 41 in FIG. 14 indicates that the component 10 can be moved relative to the drying apparatus 40a, 40b while drying the coating layer 39. Alternatively, the drying apparatus 40, 40a can also be moved relative to the stationary component 10.

According to the embodiment in FIG. 15, it is indicated that, as an alternative to manufacturing a component 10 that comprises a substrate or a film 21, the expanded particles 31a, 31b, 31c can also be placed directly into the lower mold part without a film 21 having been arranged therein in advance. The component 10 according to the invention can thus be directly manufactured from such an expandable particle foam.

If, proceeding from the view according to FIG. 15, the cavity 22 in the lower mold part 23 is completely filled with expanded particles 31a, 31b, 31c and the upper mold part (not shown in FIG. 15) is then moved into a closed position against the lower mold part 23, and the particles bake together, a bare component that does not have a film or a substrate is made in this respect.

Such a component can, as shown in FIG. 16, likewise have a coating layer 39 applied thereto:

FIG. 16 shows that, according to a view according to FIG. 14, a coating layer can also be applied directly to the cured particle foam and a step of drying can subsequently be carried out.

According to FIG. 17, as an alternative to the cathodic dip coating process, the application of a coating layer 43 as part of a powder coating method is explained: according to FIG. 17, using an application device 42, e.g. a coating gun, a powder coating layer 43 is applied to a component 10 according to FIG. 9. This component can also be guided through a drying apparatus according to FIG. 14 after the application in order to dry the coating layer.

The embodiments in FIGS. 1 to 11 describe variants of the invention in which the loose granular particles 30a, 30b, 30c made of starting material are first pre-expanded, in the container 13, and are completely expanded in the mold 23 during the baking process. However, the invention also covers variants in which particles are completely expanded in the container 13 and are placed into the mold 23 as loose, granular, completely expanded particles 31a, 31b, 31c and are sintered or baked to one another therein over the course of the baking without an increase in the volume of the expanded particles 31a, 31b, 31c taking place therein.

1. A method of making a thin component in a lightweight sandwich construction having a high-quality surface, the method comprising the following steps:
i) providing granular starting material in the form of loose granular particles of an expandable particle foam, that, when expanded, have a softening temperature of greater than 160° C.,
ii) expanding the granular particles,
iii) introducing the expanded, granular particles in the form of a granulate into a cavity of a lower mold part of a mold,
iv) closing the mold,
v) heating the mold,
vi) baking the expanded particles in the mold to form a homogeneous curable particle foam,
vii) curing the particle foam to form a molded body,
viii) opening the mold and removing the molded body therefrom,
ix) applying a coating layer to a face of the molded body, and
x) drying the coating layer.

2. The method according to claim 1, wherein step ix) and/or step x) are carried out at a temperature of above 150° C. and below the softening temperature of the expanded particle foam.

3. The method according to claim 1, further comprising the steps, before step iii), of:
a) providing a film-like substrate,
b) fitting the substrate into the lower mold part of the mold.

4. The method according to claim 3, wherein the substrate is a deep-drawn film.

5. The method according to claim 3, further comprising the step of:
xi) applying a cover layer to a face of the particle foam directed away from the substrate.

6. The method according to claim 1, further comprising the step of:
xii) processing the molded body to form a component.

7. The method according to claim 3, wherein the substrate has a wall thickness of between 0.05 mm and 13 mm.

8. The method according to claim 1, wherein the cured particle foam has a wall thickness of between 1 cm and 30 cm.

9. The method according to claim 1, wherein the component is a vehicle part for a truck or for a commercial vehicle or for a trailer.

10. The method according to claim 1, wherein the starting material is provided y expandable EPS, PP, PPSU, PSU or PEEK.

11. The method according to claim 1, further comprising, before carrying out step vi), the following step:
xiii) positioning reinforcing elements in the lower mold part such that the expanded particles surround the reinforcing elements after the particles have been introduced into the lower mold part.

12. The method according to claim 1, wherein the dried coating layer applied to the molded body has a wall thickness of between 0.01 mm and 2 mm.

13. The method according to claim 1, wherein the step of applying a coating layer takes place as part of a cathodic dip coating method.

14. The method according to claim 1, wherein the step of applying a coating layer takes place as part of a powder coating method.

15. The method according to claim 1, wherein
step ii) of expanding the particles entails only partially expanding the particles,
during step iii) the partially expanded particles are introduced into the lower mold part, and
during step vi) the partially expanded particles are baked and completely expanded.

16. The method according to claim 1, wherein in step ii) the particles are completely expanded.

17. A thin component having a high-quality surface and comprising:
a cured particle foam that has a softening temperature of greater than 160° C.
a coating layer on the component.

18. The component according to claim 17, wherein the component comprises a film between the particle foam and the coating layer and having a wall thickness of between 0.2 mm and 13 mm.

19. The component according to claim 17, wherein the cured particle foam has a wall thickness of between 1 cm and 30 cm.

20. The component according to claim 18, wherein the particle foam is expanded against the substrate.
